(19) United States
(12) Patent Application Publication
(10) Pub. No.: US 2015/0340977 A1
(43) Pub. Date: Nov. 26, 2015

(54) MOTOR DRIVE DEVICE INCLUDING FUNCTION TO DETECT FAILURE IN INVERTER AND POWER LINE

(71) Applicant: FANUC CORPORATION, Yamanashi (JP)

(72) Inventors: Masaya Tateda, Yamanashi (JP); Akira Hirai, Yamanashi (JP)

(21) Appl. No.: 14/718,202

(22) Filed: May 21, 2015

(30) Foreign Application Priority Data
May 23, 2014 (JP) 2014-106997

(51) Int. Cl. H02P 6/12

(52) U.S. Cl. CPC H02P 6/12

(57) ABSTRACT

The motor drive device includes: a three-phase inverter having switching elements and converting a direct current into an alternating current; a plurality of current detection circuits configured to detect a current that flows through a power line in each phase; a current abnormality detection unit configured to detect the presence/absence of an abnormality based on the detected currents; a failure diagnosis start unit configured to output a failure diagnosis start signal based on the abnormality detection results; an inverter switching command unit configured to output a command for performing a plurality of switching patterns in which switching of the switching elements is performed selectively so that a current flows between two selected phases; a current analysis unit configured to analyze the detected currents; and a failed part determination unit configured to determine a failed part based on the current analysis results and the switching patterns.

### CROSS-REFERENCE TO RELATED APPLICATIONS

This application is a new U.S. patent application that claims benefit of JP 2014-106997, filed on May 23, 2014, the entire content of JP 2014-106997 is hereby incorporated by reference.

### FIELD OF THE INVENTION

The present invention relates to a motor drive device and in particular, to a motor drive device having a function for detecting a failure in a power line of a motor that is connected to an inverter for driving the motor and in the inverter.

### BACKGROUND OF THE INVENTION

In order to drive a motor, it is necessary to connect a motor drive device and the motor to a power line and to cause current to flow therethrough. In the case of an alternate current (AC) motor, a three-phase alternating current is caused to flow. However, if it is not possible to cause current to flow due to a breakage of one of the three power lines or a failure in the motor drive device, and thus the motor will no longer operate normally.

Conventionally, if the motor continuing to operate in this state, an abnormal sound will occur because the current does not flow normally or the motor stops because an abnormality is detected in which the current does not flow. However, in this case, it is not possible to determine whether the cause of the abnormality that the current does not flow is a breakage of the power line or a failure in the motor drive device.

Because of this a method is known that specifies a failed part by using a motor drive device (e.g., JP 10-23795A). With this conventional technique, it is not possible to diagnose a failed part only in the state where the motor is not in operation, and therefore, the reason that the current does not flow cannot be diagnosed during the operation of the motor.

The problem of the above-described conventional technique is explained. FIG. 1 illustrates a configuration diagram of a conventional motor drive device. A conventional motor drive device 1000 includes an inverter 1001 having six switching elements Tra to Trf, and a current monitoring unit 1040. To input terminals 1031 and 1032 of the inverter 1001, a direct current is input and the direct current is converted into an alternating current by the inverter 1001 and is supplied to a motor 1020.

Between the input terminals 1031 and 1032, two circuits in each of which the switching element and a diode are connected in parallel are connected in series for each phase of the motor 1020. In other words, a parallel circuit of the switching element Tra and a diode Da and a parallel circuit of the switching element Trb and a diode Db are connected in series and the two parallel circuits are connected between the input terminals 1031 and 1032. Similarly, a circuit in which a parallel circuit of the switching element Trc and a diode Dc and a parallel circuit of the switching element Trd and a diode Dd are connected in series, and a circuit in which a parallel circuit of the switching element Tre and a diode De and a parallel circuit of the switching element Trf and a diode Df are connected in series are connected between the input terminals 1031 and 1032, respectively.

The serial connection point of the two parallel circuits of the switching element and the diode is connected to each of the U-phase, V-phase, and W-phase winding terminals of the motor. The circuits each include the switching element and the diode constitute the inverter.

In the case where the inverter that drives the motor and the motor power lines are normal, a current flows, for example, along a path indicated by a dotted arrow L illustrated in FIG. 1. However, if the switching elements Tra to Trf of the motor drive device remain in the open state and switching can be performed no longer, or motor power lines 1010a to 1010c are broken, a current no longer flows through the motor as illustrated in FIG. 2. In this case, it is possible to quickly determine that the motor drive device is in an abnormal state. However, in this state, it is not possible to determine whether the motor drive device is problematic or the motor power line is broken, and therefore, it takes time to specify a failed part.

An object of the present invention is to provide a motor drive device capable of “specifying a failed part” after “detecting a failure that prevents a current from flowing through a motor normally”, which the above-described conventional technique has not been able to provide.

### SUMMARY OF THE INVENTION

A motor drive device according to an embodiment of the present invention includes: a three-phase inverter having a plurality of switching elements and configured to convert a direct current into a three-phase alternating current for driving a motor; a plurality of current detection circuits configured to detect a current that flows through a power line in each phase that supplies the three-phase alternating current from the three-phase inverter to the motor; a current abnormality detection unit configured to detect the presence/absence of an abnormality based on the currents detected by the plurality of current detection circuits and to output abnormality detection results; a failure diagnosis start unit configured to output a failure diagnosis start signal for determining the presence/absence of a failure in the plurality of switching elements of the three-phase inverter and in the power lines based on the abnormality detection results output from the current abnormality detection unit; an inverter switching command unit configured to output a command for performing a plurality of switching patterns in which switching of the plurality of switching elements of the three-phase inverter is performed selectively so that a current flows between two phases selected from among the three phases through the switching elements and the power lines in the two selected phases based on the failure diagnosis start signal from the failure diagnosis start unit; a current analysis unit configured to analyze the currents detected by the current detection circuits when selectively performing switching of the plurality of switching elements based on the command from the inverter switching command unit; and a failed part determination unit configured to determine a failed part based on the current analysis results output from the current analysis unit and the switching patterns.

### DESCRIPTION OF THE DRAWINGS

The objects, features, and advantages of the present invention will be made clearer by the explanation of the following embodiments in association with the attached drawings wherein:

FIG. 1 is a diagram illustrating an example of a path through which a current flows in a conventional motor drive device;

FIG. 2 is a configuration diagram of the conventional motor drive device;

FIG. 3 is a configuration diagram of a motor drive device according to a first embodiment of the present invention;

FIG. 4 is a flowchart for explaining an operation procedure of the motor drive device according to the first embodiment of the present invention;

FIG. 5A is a diagram for explaining a path of a current that flows in the case where switching of switching elements Tra and Trd is performed selectively in the motor drive device according to the first embodiment of the present invention;

FIG. 5B is a diagram for explaining a path of a current that flows in the case where switching of the switching element Tra and a switching element Trf is performed selectively in the motor drive device according to the first embodiment of the present invention;

FIG. 5C is a diagram for explaining a path of a current that flows in the case where switching of switching elements Trc and Trb is performed selectively in the motor drive device according to the first embodiment of the present invention;

FIG. 5D is a diagram for explaining a path of a current that flows in the case where switching of the switching elements Trc and Trf is performed selectively in the motor drive device according to the first embodiment of the present invention;

FIG. 5E is a diagram for explaining a path of a current that flows in the case where switching of a switching element Tre and the switching element Trb is performed selectively in the motor drive device according to the first embodiment of the present invention;

FIG. 5F is a diagram for explaining a path of a current that flows in the case where switching of the switching elements Tre and Trd is performed selectively in the motor drive device according to the first embodiment of the present invention;

FIG. 6A is a diagram for explaining a path of a current that flows in the case where switching of the switching elements Tra and Trd is performed selectively on the condition that a breakage has occurred in a power line in the motor drive device according to the first embodiment of the present invention;

FIG. 6B is a diagram for explaining a path of a current that flows in the case where switching of the switching elements Tra and Trf is performed selectively on the condition that a breakage has occurred in the power line in the motor drive device according to the first embodiment of the present invention;

FIG. 6C is a diagram for explaining a path of a current that flows in the case where switching of the switching elements Trc and Trb is performed selectively on the condition that a breakage has occurred in the power line in the motor drive device according to the first embodiment of the present invention;

FIG. 6D is a diagram for explaining a path of a current that flows in the case where switching of the switching elements Trc and Trf is performed selectively on the condition that a breakage has occurred in the power line in the motor drive device according to the first embodiment of the present invention;

FIG. 6E is a diagram for explaining a path of a current that flows in the case where switching of the switching elements Tre and Trb is performed selectively on the condition that a breakage has occurred in the power line in the motor drive device according to the first embodiment of the present invention;

FIG. 6F is a diagram for explaining a path of a current that flows in the case where switching of the switching elements Tre and Trd is performed selectively on the condition that a breakage has occurred in the power line in the motor drive device according to the first embodiment of the present invention;

FIG. 7A is a diagram for explaining a path of a current that flows in the case where switching of the switching elements Tra and Trd is performed selectively on the condition that an abnormality has occurred in a switching element in the motor drive device according to the first embodiment of the present invention;

FIG. 7B is a diagram for explaining a path of a current that flows in the case where switching of the switching elements Tra and Trf is performed selectively on the condition that an abnormality has occurred in the switching element in the motor drive device according to the first embodiment of the present invention;

FIG. 7C is a diagram for explaining a path of a current that flows in the case where switching of the switching elements Trc and Trb is performed selectively on the condition that an abnormality has occurred in the switching element in the motor drive device according to the first embodiment of the present invention;

FIG. 7D is a diagram for explaining a path of a current that flows in the case where switching of the switching elements Trc and Trf is performed selectively on the condition that an abnormality has occurred in the switching element in the motor drive device according to the first embodiment of the present invention;

FIG. 7E is a diagram for explaining a path of a current that flows in the case where switching of the switching elements Tre and Trb is performed selectively on the condition that an abnormality has occurred in the switching element in the motor drive device according to the first embodiment of the present invention;

FIG. 7F is a diagram for explaining a path of a current that flows in the case where switching of the switching elements Tre and Trd is performed selectively on the condition that an abnormality has occurred in the switching element in the motor drive device according to the first embodiment of the present invention;

FIG. 8 is a configuration diagram of a motor drive device according to another aspect of the first embodiment of the present invention;

FIG. 9 is a configuration diagram of a motor drive device according to a second embodiment of the present invention; and

FIG. 10 is a flowchart for explaining an operation procedure of the motor drive device according to the second embodiment of the present invention.

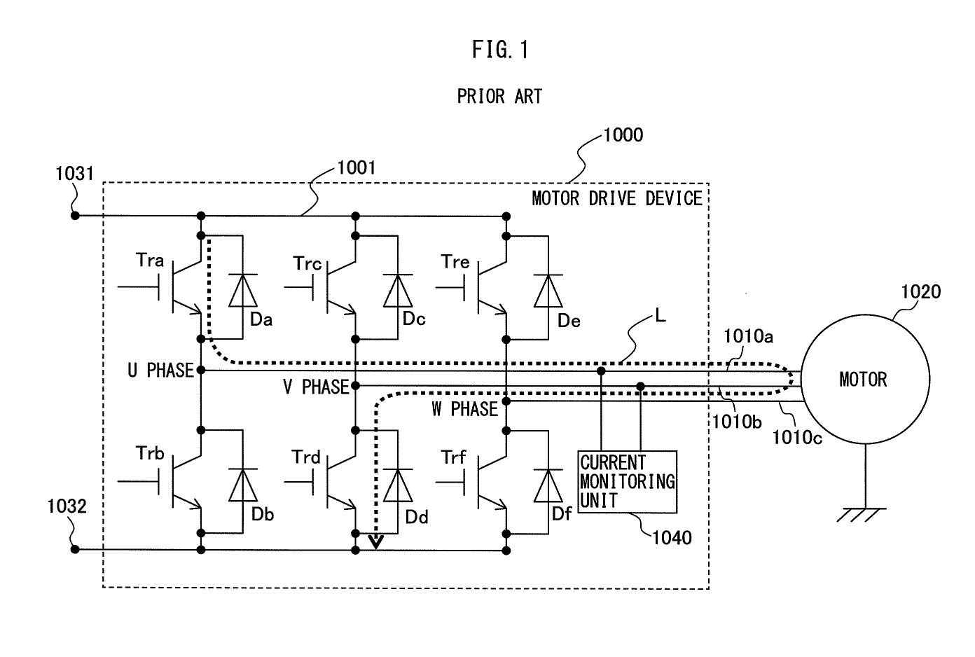

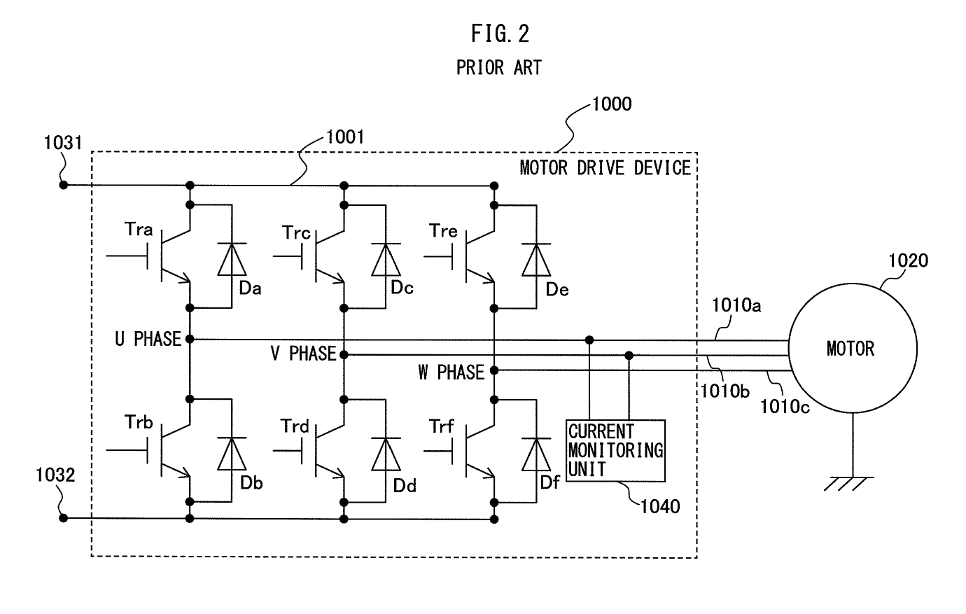

### DETAILED DESCRIPTION OF THE PREFERRED EMBODIMENTS

In the following, with reference to the drawings, a motor drive device according to the present invention is explained. However, it should be noted that the technical scope of the present invention is not limited to embodiments and encompasses the inventions described in the claims and equivalents thereof.

### First Embodiment

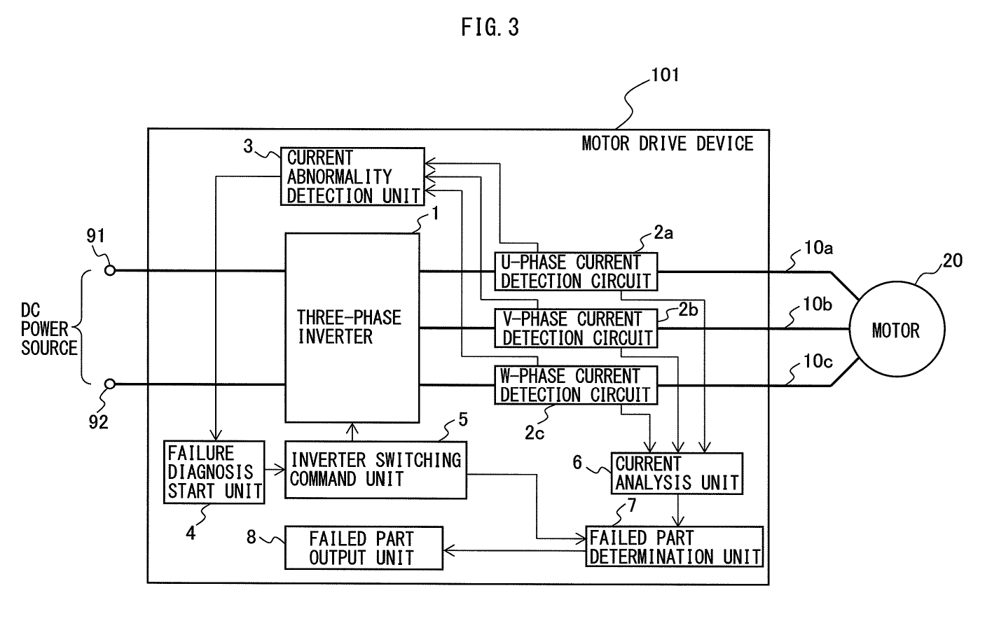

A motor drive device according to a first embodiment of the present invention is explained by using the drawings. FIG. 3 illustrates a configuration diagram of a motor drive device according to the first embodiment of the present invention. A motor drive device 101 according to the first embodiment of the present invention includes: a three-phase inverter 1 having a plurality of switching elements and configured to convert a direct current into a three-phase alternating current for driving a motor; a plurality of current detection circuits 2a to 2c configured to detect currents that flow through power lines 10a to 10c in the respective phases that supply the three-phase alternating current from the three-phase inverter 1 to a motor 20; a current abnormality detection unit 3 configured to detect the presence/absence of an abnormality based on the currents detected by the plurality of current detection circuits 2a to 2c and to output abnormality detection results; a failure diagnosis start unit 4 configured to output a failure diagnosis start signal for determining the presence/absence of a failure in the plurality of switching elements of the three-phase inverter 1 and in the power lines 10a to 10c based on the abnormality detection results output from the current abnormality detection unit 3; an inverter switching command unit 5 configured to output a command for performing a plurality of switching patterns in which switching of the plurality of switching elements of the three-phase inverter 1 is performed selectively so that a current flows between two phases selected from among the three phases through the switching elements and the power lines in the two selected phases based on the failure diagnosis start signal from the failure diagnosis start unit 4; a current analysis unit 6 configured to analyze the currents detected by the current detection circuits 2a to 2c when selectively performing switching of the plurality of switching elements based on the command from the inverter switching command unit 5; and a failed part determination unit 7 configured to determine a failed part based on the current analysis results output from the current analysis unit 6 and the switching patterns.

The three-phase inverter 1 includes two input terminals 91 and 92 and to these input terminals, a direct-current (DC) power source (not illustrated) is connected. The three-phase inverter 1 includes a plurality of switching elements and converts a direct current input from the direct-current power source into a three-phase alternating current for driving the motor 20. The three-phase inverter 1 and the motor 20 are connected by the U-phase power line 10a, the V-phase power line 10b, and the W-phase power line 10c, and the three-phase alternating current output from the three-phase inverter 1 is supplied to the motor 20 via the power lines 10a to 10c.

The power lines 10a to 10c in the respective phases are provided with the plurality of current detection circuits 2a to 2c, respectively, for detecting the three-phase alternating current supplied from the three-phase inverter 1 to the motor 20. In other words, the U-phase power line 10a is provided with the U-phase current detection circuit 2a for detecting a U-phase current, the V-phase power line 10b is provided with the V-phase current detection circuit 2b for detecting a V-phase current, and the W-phase power line 10c is provided with the W-phase current detection circuit 2c for detecting a W-phase current.

Data on the currents detected by the plurality of current detection circuits 2a to 2c is output to the current abnormality detection unit 3. The current abnormality detection unit 3 detects the presence/absence of an abnormality by comparing the acquired data about the currents with a reference value and outputs abnormality detection results. The current abnormality detection unit 3 outputs the abnormality detection results indicating that a current value is abnormal in the case where it is determined that at least one current value among the U-phase current, the V-phase current, and the W-phase current is abnormal. The plurality of current detection circuits 2a to 2c detects the currents that flow through the power lines 10a to 10c in the respective phases in the state where the motor 20 is being driven, and therefore, it is possible to detect that a certain abnormality has occurred even in the case where a current that flows through any of the power lines is abnormal without the need to stop the motor 20.

As described above, when detecting that a current that flows through the power line is abnormal in the state where the motor 20 is in operation, the current abnormality detection unit 3 stops the operation of the motor 20 and starts a failure diagnosis for specifying the part where an abnormality has occurred. Then, the abnormality detection results output from the current abnormality detection unit 3 are output to the failure diagnosis start unit 4 and the failure diagnosis start unit 4 outputs the failure diagnosis start signal for diagnosing the plurality of switching elements of the three-phase inverter 1 and the power lines 10a to 10c is determined to be a failed part.

The failure diagnosis start signal output from the failure diagnosis start unit 4 is input to the inverter switching command unit 5. The inverter switching command unit 5 outputs a command to perform a plurality of switching patterns to the plurality of switching elements, in which switching of the plurality of switching elements of the three-phase inverter 1 is performed selectively so that a current flows between the two phases (between U phase and V phase) selected from among the three phases, i.e., the U phase, the V phase, and the W phase, through the switching elements in the two selected phases (e.g., U phase and V phase) and the power lines. Details of the switching pattern will be described later.

In accordance with the plurality of switching patterns, switching of the plurality of switching elements is performed selectively based on the command from the inverter switching command unit 5. At this time, the U-phase current detection circuit 2a, the V-phase current detection circuit 2b, and the W-phase current detection circuit 2c detect the U-phase current, the V-phase current, and the W-phase current, respectively, for each switching pattern. Each current value of the detected U-phase current, the V-phase current, and the W-phase current is output to the current analysis unit 6 and the current analysis unit 6 analyzes the acquired current values.

The results of the analysis performed by the current analysis unit 6 are output to the failed part determination unit 7. The failed part determination unit 7 acquires the switching patterns from the inverter switching command unit 5 and determines a failed part based on the current analysis results output from the current analysis unit 6 and the switching patterns. A method for diagnosing a failed part will be described later.

A failed part output unit 8 configured to output information or data about a failed part based on the determination results of the failed part determination unit 7 may be further provided.

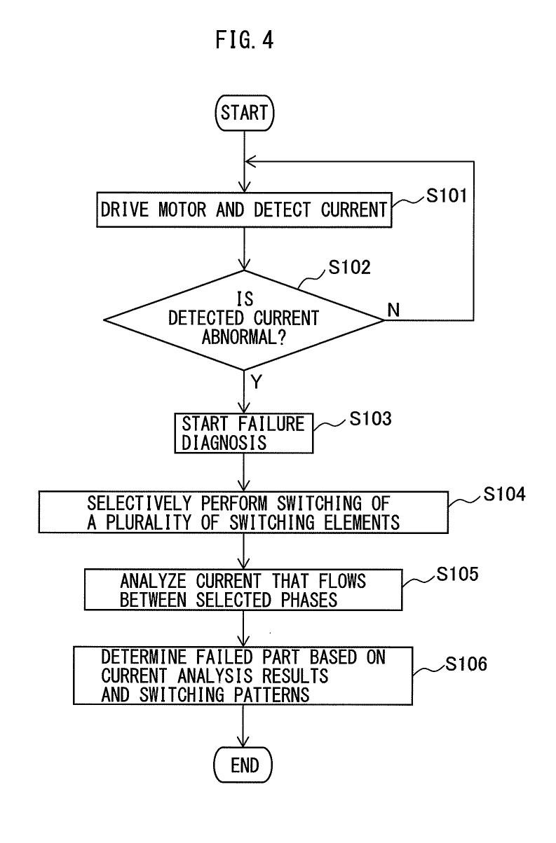

Next, operation of the motor drive device according to the first embodiment of the present invention is explained based on the drawings. FIG. 4 is a flowchart for explaining the operation procedure of the motor drive device 101 according to the first embodiment of the present invention.

First, at step S101, in the state where the motor 20 is being driven, the U-phase current detection circuit 2a, the V-phase current detection circuit 2b, and the W-phase current detection circuit 2c detect the U-phase current, the V-phase current, and the W-phase current that flow through the U-phase power line 10a, the V-phase power line 10b, and the W-phase power line 10c, respectively, which supply the three-phase alternating current from the three-phase inverter 1 to the motor 20. The detection results are output to the current abnormality detection unit 3.

Next, at step S102, the current abnormality detection unit 3 determines the presence/absence of an abnormality based on the currents detected by the plurality of current detection circuits 2a to 2c. The current abnormality detection unit 3 has already acquired the data about the U-phase current, the V-phase current, and the W-phase current, and therefore, it is possible to determine that the detected currents are abnormal if at least one of the current values of the detected currents does not fall within a predetermined range from the reference value. In the case where the detected currents are normal, the current abnormality detection unit 3 returns to step S101 and continues monitoring of the currents that flow through the power lines.

On the other hand, in the case where the detected currents are abnormal, at step S103, the motor is stopped and a failure diagnosis is started. The failure diagnosis is carried out as follows.

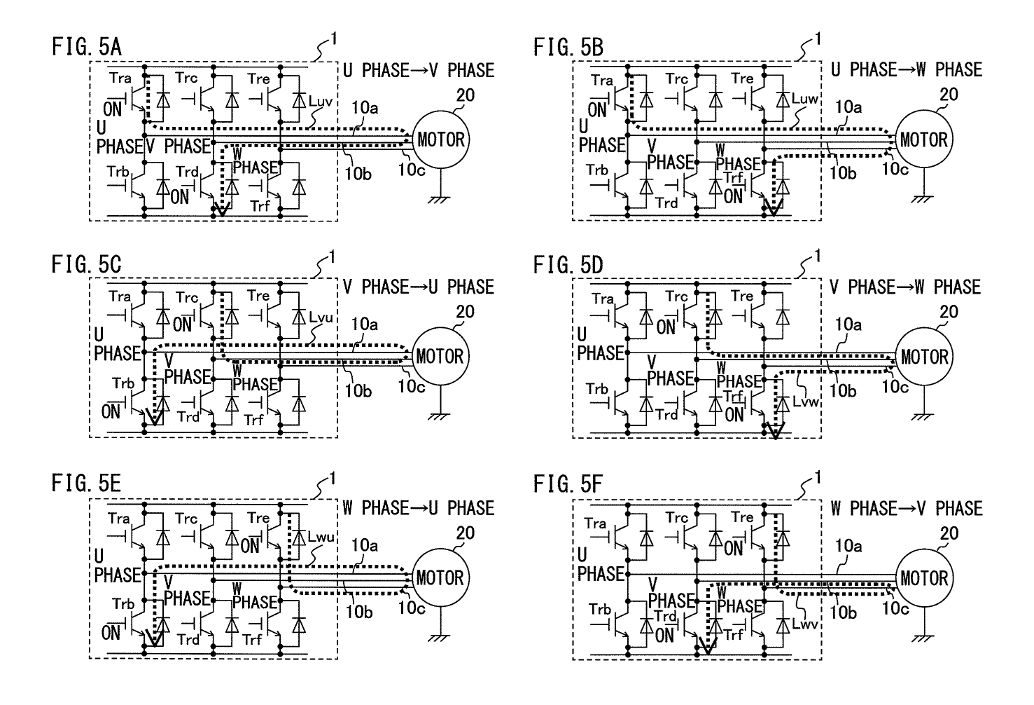

First, at step S104, switching of the plurality of switching elements of the three-phase inverter is performed selectively so that a current flows between two phases selected from among the three phases through the switching elements and the power lines in the two selected phases. The path of a current that flows in the case where switching of the switching elements is performed selectively in the motor drive device according to the first embodiment of the present invention is illustrated in FIG. 5A to FIG. 5F.

FIG. 5A illustrates a first switching pattern that brings only an upper-arm transistor Tra in the U phase and a lower-arm transistor Trd in the V phase into the on-state and the other transistors into the off-state so that a current flows between the U phase and the V phase. At this time, in the normal state, as indicated by a dotted arrow Luv, the current flows via the upper-arm transistor Tra in the U phase, the U-phase power line 10a, the V-phase power line 10b, and the lower-arm transistor Trd in the V phase.

FIG. 5B illustrates a second switching pattern that brings only the upper-arm transistor Tra in the U phase and a lower-arm transistor Trf in the W phase into the on-state and the other transistors into the off-state so that a current flows between the U phase and the W phase. At this time, in the normal state, as indicated by a dotted arrow Luw, the current flows via the upper-arm transistor Tra in the U phase, the U-phase power line 10a, the W-phase power line 10c, and the lower-arm transistor Trf in the W phase.

FIG. 5C illustrates a third switching pattern that brings only an upper-arm transistor Trc in the V phase and a lower-arm transistor Trb in the U phase into the on-state and the other transistors into the off-state so that a current flows between the V phase and the U phase. At this time, in the normal state, as indicated by a dotted arrow Lvu, the current flows via the upper-arm transistor Trc in the V phase, the V-phase power line 10b, the U-phase power line 10a, and the lower-arm transistor Trb in the U phase.

FIG. 5D illustrates a fourth switching pattern that brings only the upper-arm transistor Trc in the V phase and the lower-arm transistor Trf in the W phase into the on-state and the other transistors into the off-state so that a current flows between the V phase and the W phase. At this time, in the normal state, as indicated by a dotted arrow Lvw, the current flows via the upper-arm transistor Trc in the V phase, the V-phase power line 10b, the W-phase power line 10c, and the lower-arm transistor Trf in the W phase.

FIG. 5E illustrates a fifth switching pattern that brings only an upper-arm transistor Tre in the W phase and the lower-arm transistor Trb in the U phase into the on-state and the other transistors into the off-state so that a current flows between the W phase and the U phase.

At this time, in the normal state, as indicated by a dotted arrow Lwu, the current flows via the upper-arm transistor Tre in the W phase, the W-phase power line 10c, the U-phase power line 10a, and the lower-arm transistor Trb in the U phase.

FIG. 5F illustrates a sixth switching pattern that brings only the upper-arm transistor Tre in the W phase and the lower-arm transistor Trd in the V phase into the on-state and the other transistors into the off-state so that a current flows between the W phase and the V phase. At this time, in the normal state, as indicated by a dotted arrow Lwv, the current flows via the upper-arm transistor Tre in the W phase, the W-phase power line 10c, the V-phase power line 10b, and the lower-arm transistor Trd in the V phase.

At step S104, one of the first to sixth switching patterns described above is selected and current that flows between specific phases is detected.

Next, at step S105, the current that flows between the selected phases is analyzed. For example, in the case where the first switching pattern is performed, the current analysis unit 6 analyzes the U-phase current detected by the U-phase current detection circuit 2a and the V-phase current detected by the V-phase current detection circuit 2b and determines whether or not the current values are normal.

Next, at step S106, a failed part is determined based on the current analysis results and the switching patterns. Next, a determination method of a failed part is explained. As a failed part, it is understood that the case is roughly divided into a case where a switching element within the three-phase inverter has failed and a case where a power line has broken, and therefore, for each case, a failure diagnosis method is explained.

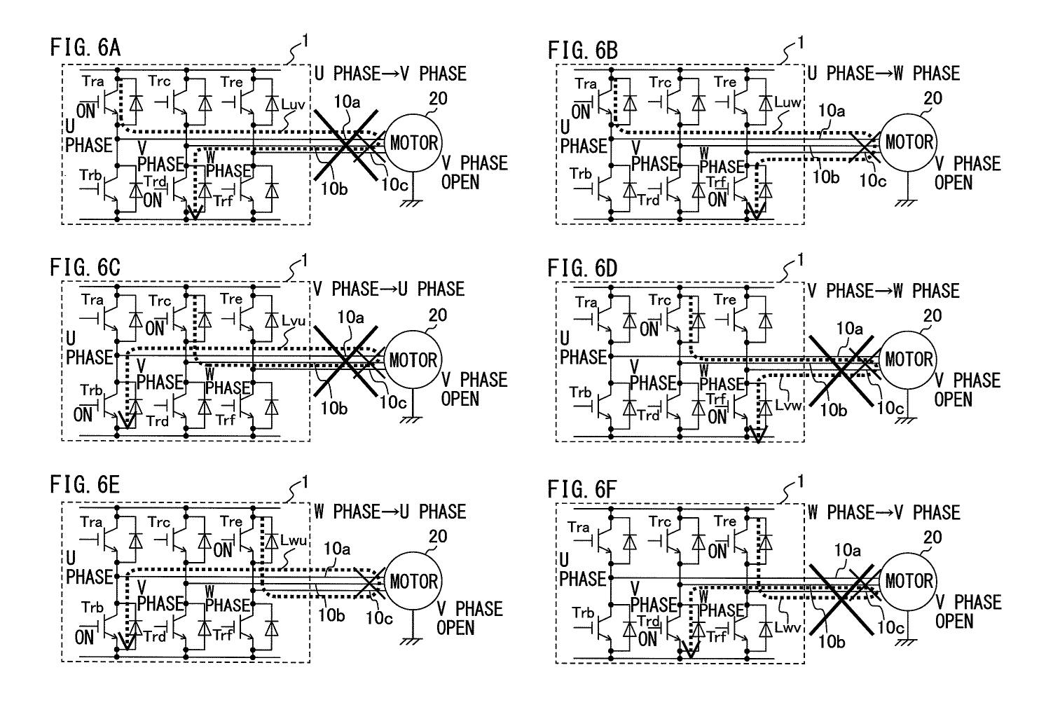

First, the failure diagnosis method in the case where a power line is broken is explained. FIGS. 6A to 6F are diagrams for explaining the paths of a current that flows when various switching patterns are performed in the case where a breakage has occurred in a power line in the motor drive device according to the first embodiment of the present invention. As an example, the case where the V-phase power line 10b is broken is explained. In FIGS. 6A to 6F, a x-mark, i.e., cross mark illustrated so as to overlap the V-phase power line 10b indicates the breakage.

First, as illustrated in FIG. 6A, the first switching pattern to bring only the upper-arm transistor Tra in the U phase and the lower-arm transistor Trd in the V phase into the on-state and the other transistors into the off-state is performed so that a current flows between the U phase and the V phase. At this time, if normal, the current flows through the path indicated by the dotted arrow Luv. However, the V-phase power line 10b is broken, and therefore, the current does not flow along the dotted arrow Luv. The large x-mark illustrated in FIG. 6A indicates that the current does not flow. In this stage, it is possible to determine that an abnormality has occurred in any of the upper-arm transistor Tra in the U phase, the U-phase power line 10a, the V-phase power line 10b, and the lower-arm transistor Trd in the V phase. Next, as illustrated in FIG. 6B, the second switching pattern to bring only the upper-arm transistor Tra in the U phase and the lower-arm transistor Trf in the W phase into the on-state and the other transistors into the off-state is performed so that a current flows between the U phase and the W phase. At this time, the path of the current indicated by the dotted arrow Luw passes through the upper-arm transistor Tra in the U phase, the U-phase power line 10a, the W-phase power line 10c, and the lower-arm transistor Trf in the W phase, but does not pass through the V-phase power line 10b, and therefore, a normal current is detected. As a result, it is possible to determine that no abnormality has occurred in these elements.

Next, as illustrated in FIG. 6C, the third switching pattern to bring only the upper-arm transistor Trc in the V phase and the lower-arm transistor Trb in the U phase into the on-state and the other transistors into the off-state is performed so that a current flows between the V phase and the U phase. At this time, if normal, the current flows through the path indicated by the dotted arrow Lvu. However, the V-phase power line 10b is broken, and therefore, the current does not flow along the dotted arrow Lvu. The large x-mark illustrated in FIG. 6C indicates that the current does not flow. In this stage, it is possible to determine that an abnormality has occurred in any of the upper-arm transistor Trc in the V phase, the V-phase power line 10b, the U-phase power line 10a, and the lower-arm transistor Trb in the U phase.

Next, as illustrated in FIG. 6D, the fourth switching pattern to bring only the upper-arm transistor Trc in the V phase and the lower-arm transistor Trf in the W phase into the on-state and the other transistors into the off-state is performed so that a current flows between the V phase and the W phase. At this time, if normal, the current flows through the path indicated by the dotted arrow Lvw. However, the V-phase power line 10b is broken; and therefore, the current does not flow along the dotted arrow Lvw. The large x-mark illustrated in FIG. 6D indicates that the current does not flow. In this stage, it is possible to determine that an abnormality has occurred in any of the upper-arm transistor Trc in the V phase, the V-phase power line 10b, the W-phase power line 10c, and the lower-arm transistor Trf in the W phase.

Next, as illustrated in FIG. 6E, the fifth switching pattern to bring only the upper-arm transistor Tre in the W phase and the lower-arm transistor Trb in the U phase into the on-state and the other transistors into the off-state is performed so that a current flows between the W phase and the U phase. At this time, the path of the current indicated by the dotted arrow Lwu passes through the upper-arm transistor Tre in the W phase, the W-phase power line 10c, the U-phase power line 10a, and the lower-arm transistor Trb in the U phase, but does not pass through the V-phase power line 10b, and therefore, a normal current is detected. As a result, it is possible to determine that no abnormality has occurred in these elements.

Next, as illustrated in FIG. 6F, the sixth switching pattern to bring only the upper-arm transistor Tre in the W phase and the lower-arm transistor Trd in the V phase into the on-state and the other transistors into the off-state is performed so that a current flows between the W phase and the V phase. At this time, if normal, the current flows through the path indicated by the dotted arrow Lwv. However, the V-phase power line 10b is broken, and therefore, the current does not flow along the dotted arrow Lwv. The large x-mark illustrated in FIG. 6F indicates that the current does not flow. In this stage, it is possible to determine that an abnormality has occurred in any of the upper-arm transistor Tre in the W phase, the W-phase power line 10c, the V-phase power line 10b, and the lower-arm transistor Trd in the V phase.

From the currents that flow in the case where the first to sixth switching patterns as above are performed and the switching patterns, it is known that any of the upper-arm transistor Trc in the V phase, the lower-arm transistor Trd in the V phase, and the V-phase power line 10b is abnormal. However, it is rare that two or more parts fail at the same time, such as in the case where the upper-arm transistor and the lower-arm transistor fail at the same time, and usually, there is only one failed part. Further, as will be described later, in the case where only the switching element fails, it is possible to specify the part. Consequently, it is possible to determine that the abnormal part is the V-phase power line 10b.

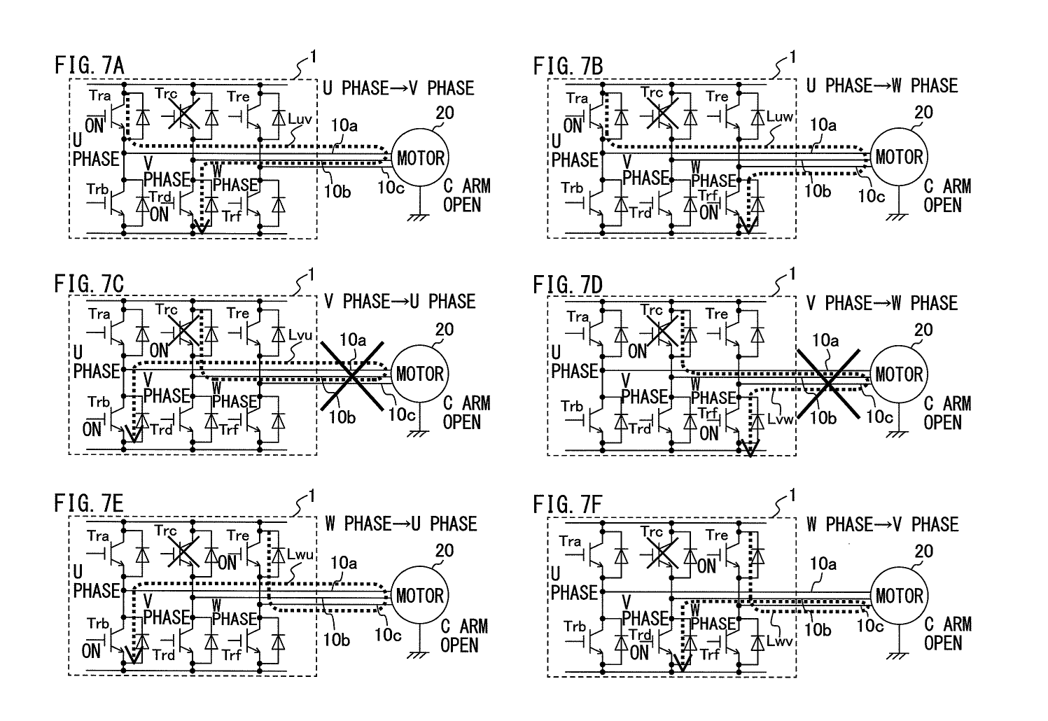

Next, the failure diagnosis method in the case where a switching element is abnormal is explained. FIGS. 7A to 7F are diagrams for explaining the paths of a current that flows when various switching patterns are performed in the case where an abnormality has occurred in a switching element in the motor drive device according to the first embodiment of the present invention. As an example, the case is explained where the upper-arm transistor (C-arm) Trc in the V phase is abnormal. In FIGS. 7A to 7F, the x-mark illustrated so as to overlap the upper-arm transistor Trc in the V phase indicates the abnormality.

First, as illustrated in FIG. 7A, the first switching pattern to bring only the upper-arm transistor Tra in the U phase and the lower-arm transistor Trd in the V phase into the on-state and the other transistors into the off-state is performed so that a current flows between the U phase and the V phase. At this time, the path of the current indicated by the dotted arrow Luv passes through the upper-arm transistor Tra in the U phase, the U-phase power line 10a, the V-phase power line 10b, and the lower-arm transistor Trd in the V phase, but does not pass through the upper-arm transistor Trc in the V phase, and therefore, a normal current is detected. As a result, it is possible to determine that no abnormality has occurred in these elements.

Next, as illustrated in FIG. 7B, the second switching pattern to bring only the upper-arm transistor Tra in the U phase and the lower-arm transistor Trf in the W phase into the on-state and the other transistors into the off-state is performed so that a current flows between the U phase and the W phase. At this time, the path of the current indicated by the dotted arrow Luw passes through the upper-arm transistor Tra in the U phase, the U-phase power line 10a, the W-phase power line 10c, and the lower-arm transistor Trf in the W phase, but does not pass through the upper-arm transistor Trc in the V phase, and therefore, a normal current is detected. As a result, it is possible to determine that no abnormality has occurred in these elements.

Next, as illustrated in FIG. 7C, the third switching pattern to bring only the upper-arm transistor Trc in the V phase and the lower-arm transistor Trb in the U phase into the on-state and the other transistors into the off-state is performed so that a current flows between the V phase and the U phase. At this time, if normal, the current flows through the path indicated by the dotted arrow Lvu. However, the upper-arm transistor Trc in the V phase is abnormal, and therefore, the current does not flow along the dotted arrow Lvu. The large x-mark illustrated in FIG. 7C indicates that the current does not flow. In this stage, it is possible to determine that an abnormality has occurred in any of the upper-arm transistor Trc in the V phase, the V-phase power line 10b, the U-phase power line 10a, and the lower-arm transistor Trb in the U phase.

Next, as illustrated in FIG. 7D, the fourth switching pattern to bring only the upper-arm transistor Trc in the V phase and the lower-arm transistor Trf in the W phase into the on-state and the other transistors into the off-state is performed so that a current flows between the V phase and the W phase. At this time, if normal, the current flows through the path indicated by the dotted arrow Lvw. However, the upper-arm transistor Trc in the V phase is abnormal, and therefore, the current does not flow along the dotted arrow Lvw. The large x-mark illustrated in FIG. 7D indicates that the current does not flow. In this stage, it is possible to determine that an abnormality has occurred in any of the upper-arm transistor Trc in the V phase, the V-phase power line 10b, the W-phase power line 10c, and the lower-arm transistor Trf in the W phase.

Next, as illustrated in FIG. 7E, the fifth switching pattern to bring only the upper-arm transistor Tre in the W phase and the lower-arm transistor Trb in the U phase into the on-state and the other transistors into the off-state is performed so that a current flows between the W phase and the U phase. At this time, the path of the current indicated by the dotted arrow Lwu passes through the upper-arm transistor Tre in the W phase, the W-phase power line 10c, the U-phase power line 10a, and the lower-arm transistor Trb in the U phase, but does not pass through the upper-arm transistor Trc in the V phase, and therefore, a normal current is detected. As a result, it is possible to determine that no abnormality has occurred in these elements.

Next, as illustrated in FIG. 7F, the sixth switching pattern to bring only the upper-arm transistor Tre in the W phase and the lower-arm transistor Trd in the V phase into the on-state and the other transistors into the off-state is performed so that a current flows between the W phase and the V phase. At this time, the path of the current indicated by the dotted arrow Lwv passes through the upper-arm transistor Tre in the W phase, the W-phase power line 10c, the V-phase power line 10b, and the lower-arm transistor Trd in the V phase, but does not pass through the upper-arm transistor Trc in the V phase, and therefore, a normal current is detected. As a result, it is possible to determine that no abnormality has occurred in these elements.

Failed parts that are supposed from the first to sixth switching patterns and the analysis results of the detected currents described above are summarized as in a table below.

TABLE 1

| Swithing | | | | | | | | | |
|---|---|---|---|---|---|---|---|---|---|
| pattern | Tra | Trb | Trc | Trd | Tre | Trf | 10a | 10b | 10c |
| 1 | ∘ | | | ∘ | | | ∘ | ∘ | |
| 2 | ∘ | | | | | ∘ | ∘ | | ∘ |
| 3 | | x | x | | | | x | x | |
| 4 | | | x | | | x | | x | x |
| 5 | | ∘ | | | ∘ | | ∘ | | ∘ |
| 6 | | | | ∘ | ∘ | | | ∘ | ∘ |

In the above described table, a circle indicates that the operation is normal and a x-mark indicates that there is a possibility that the operation will be abnormal. In the case where any one of the first to sixth switching patterns verifies that the operation is normal, it is possible to determine that the operation of the element is normal. For example, the results of performing the third switching pattern indicate that there is a possibility that the operation of the lower-arm transistor Trb in the U phase will be abnormal, but the results of performing the fifth switching pattern verify that the operation is normal.

In the above described table, the element whose operation is verified to be abnormal is only the upper-arm transistor Trc in the V phase. Therefore, it is possible to determine that the failed part is the upper-arm transistor Trc in the V phase.

In the above explanation, the failure diagnosis method in the case where the V-phase power line and the upper-arm transistor Trc in the V phase are abnormal is explained, but it is possible to diagnose a failed part in the same manner also in the case where another power line and another switching element are abnormal.

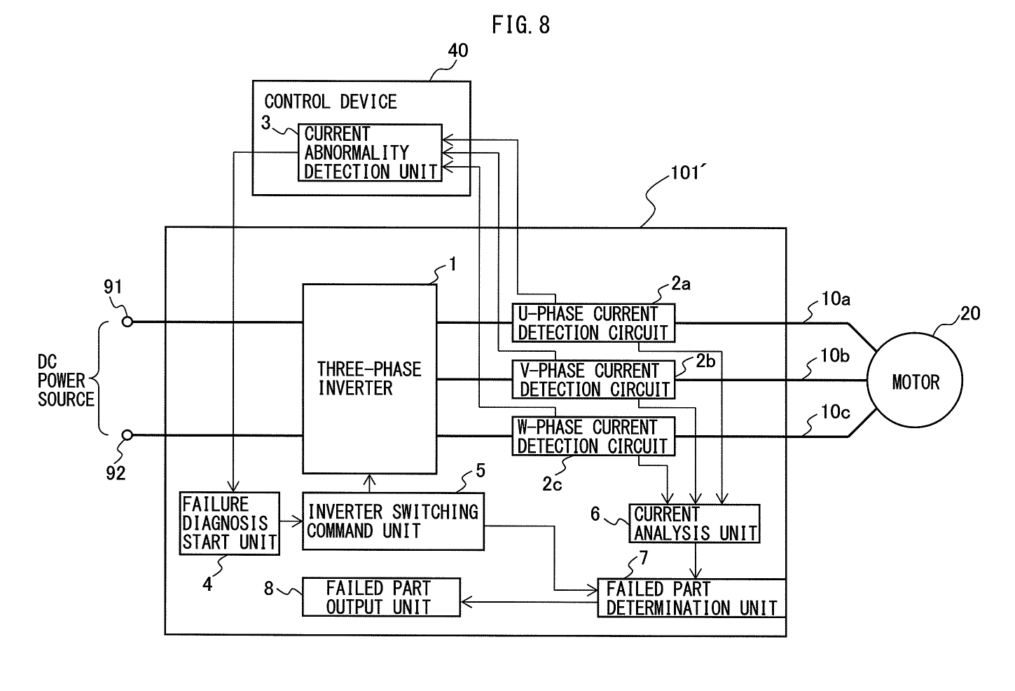

In the motor drive device 101 according to the first embodiment described above, the configuration in which the current abnormality detection unit 3 is provided within the motor drive device 101 is explained, but the configuration is not limited to the configuration such as this. For example, as illustrated in FIG. 8, it may also be possible to provide the current abnormality detection unit 3 within a control device 40 provided outside a motor drive device 101′.

### Second Embodiment

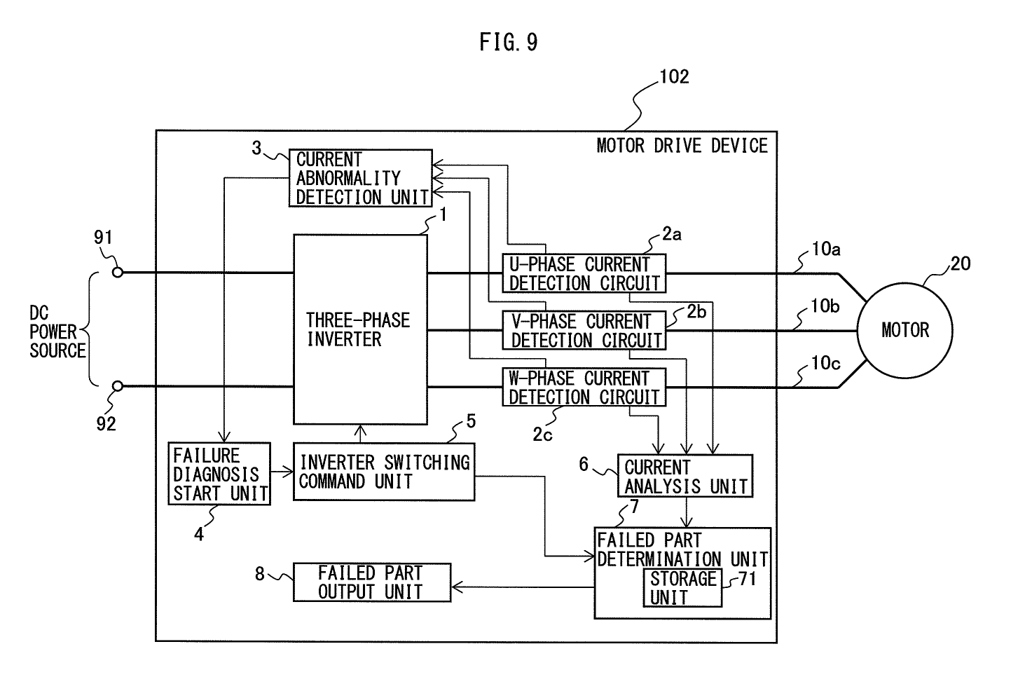

Next, a motor drive device according to a second embodiment of the present invention is explained. FIG. 9 is a configuration diagram of a motor drive device according to the second embodiment of the present invention. A motor drive device 102 according to the second embodiment differs from the motor drive device 101 according to the first embodiment in further including a storage unit 71 configured to store states of currents between each phase detected by a plurality of current detection circuits and switching patterns when a plurality of switching patterns is performed. Other configurations of the motor drive device 102 according to the second embodiment are the same as the configurations of the motor drive device 101 according to the first embodiment, and therefore, a detailed explanation is omitted.

In the motor drive device 101 according to the first embodiment, a plurality of switching patterns is performed and a failed part is determined each time the switching pattern is performed, but the present embodiment is characterized in that the failed part determination unit 7 specifies the switching element or the power line in which a failure has occurred by analyzing the switching pattern that causes the current to be abnormal based on the current states and the switching patterns stored in the storage unit 71.

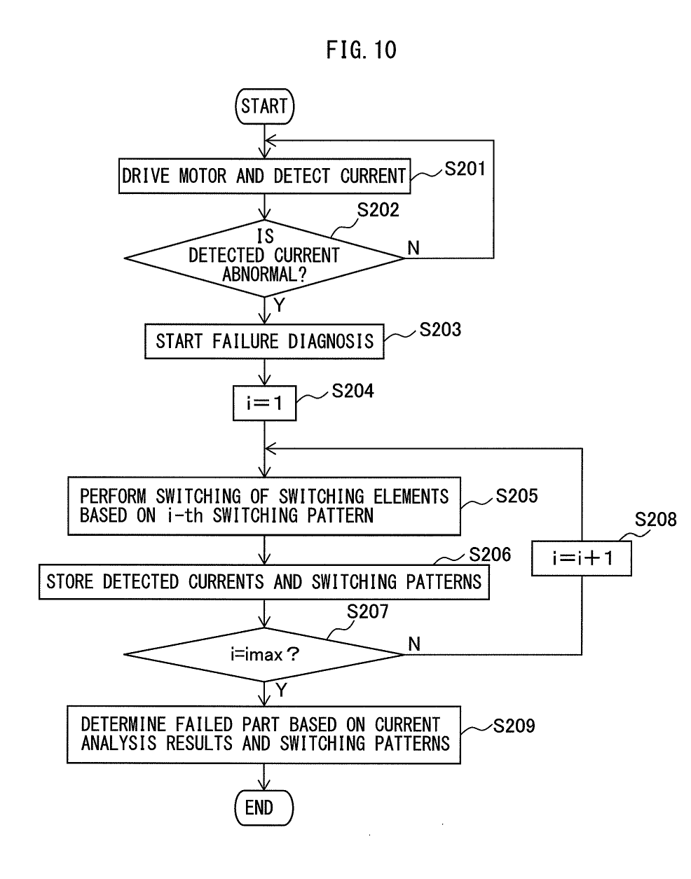

Next, an operation procedure of the motor drive device 102 according to the second embodiment of the present invention is explained by using the flowchart illustrated in FIG. 10.

First, at step S201, in the state where the motor 20 is being driven, the U-phase current detection circuit 2a, the V-phase current detection circuit 2b, and the W-phase current detection circuit 2c detect the U-phase current, the V-phase current, and the W-phase current that flow through the U-phase power line 10a, the V-phase power line 10b, and the W-phase power line 10c, respectively, which supply a three-phase alternating current from the three-phase inverter 1 to the motor 20. The detection results are output to the current abnormality detection unit 3.

Next, at step S202, the current abnormality detection unit 3 determines the presence/absence of an abnormality based on the currents detected by the plurality of current detection circuits 2a to 2c. The current abnormality detection unit 3 has already acquired the data about the U-phase current, the V-phase current, and the W-phase current, and therefore, it is possible to determine that the detected currents are abnormal if at least one of the current values of the detected currents does not fall within a predetermined range from the reference value. In the case where the detected currents are normal, the current abnormality detection unit 3 returns to step S201 and continues monitoring of the currents that flow through the power lines.

On the other hand, in the case where the detected currents are abnormal, at step S203, the motor is stopped and a failure diagnosis is started. The failure diagnosis is performed in the following procedure.

First, at step S204, i=1 is set. The letter “i” is an integer indicating the number of the switching pattern (i.e., indicating an i-th switching pattern).

Next, at step S205, switching of the switching elements within the three-phase inverter 1 is performed selectively based on the i-th switching pattern. For example, in the case where the first switching pattern is performed, as illustrated in FIG. 5A, only the upper-arm transistor Tra in the U phase and the lower-arm transistor Trd in the V phase are brought into the on-state and the other transistors are brought into the off-state so that a current flows between the U phase and the V phase.

Next, at step S206, the detected current and the switching pattern are stored in the storage unit 71. Next, at step S207, whether i is equal to imax (i=imax) or not is determined. In this case, imax is the maximum value of i and, for example, in the case where six types of switching patterns are performed, imax=6. In the case where i is not equal to imax, in other words, the detection of the currents for all the switching patterns has not been completed yet, at step S208, i is incremented by one (i is set to i+1 (i=i+1)), and the processing returns to step S205 and the current detection is performed in accordance with the next switching pattern.

In the case where it is determined that i is equal to imax (i=imax) at step S207, in other words, the current detection for all the switching patterns has completed, a failed part is determined based on the current analysis results and the switching patterns at step S209.

As above, in the present embodiment, it is possible to determine a failed part based on the current analysis results and the switching patterns after performing all the switching patterns, and therefore, it is possible to quickly determine a failed part.

According to the present invention, it is possible to easily specify a failed part after detecting a failure that prevents a current from flowing normally.

What is claimed is:

1. A motor drive device comprising:
a three-phase inverter including a plurality of switching elements and configured to convert direct current into three-phase alternating current for driving a motor;
a plurality of current detection circuits configured to detect current that flows through a power line in each phase that supplies the three-phase alternating current from the three-phase inverter to the motor;
a current abnormality detection unit configured to detect the presence/absence of an abnormality based on the currents detected by the plurality of current detection circuits and to output abnormality detection results;
a failure diagnosis start unit configured to output a failure diagnosis start signal for determining the presence/absence of a failure in the plurality of switching elements of the three-phase inverter and in the power lines based on the abnormality detection results output from the current abnormality detection unit;
an inverter switching command unit configured to output a command for performing a plurality of switching patterns in which switching of the plurality of switching elements of the three-phase inverter is performed selectively so that current flows between two phases selected from among the three phases through the switching elements and the power lines in the two selected phases based on the failure diagnosis start signal from the failure diagnosis start unit;
a current analysis unit configured to analyze the currents detected by the current detection circuits when selectively performing switching of the plurality of switching elements based on the command from the inverter switching command unit; and
a failed part determination unit configured to determine a failed part based on the current analysis results output from the current analysis unit and the switching patterns.

2. The motor drive device according to claim 1, further comprising a storage unit configured to store states of currents between each phase detected by the plurality of current detection circuits when the plurality of switching patterns is performed.

3. The motor drive device according to claim 2, wherein the failed part determination unit specifies a failure in the plurality switching elements or a failure in the power lines by analyzing the switching pattern that causes the current to be abnormal based on the states of currents and the switching patterns stored in the storage unit.

4. The motor drive device according to claim 1, further comprising a failed part output unit configured to output a failed part based on the determination results of the failed part determination unit.
